(19) United States
(12) Patent Application Publication
(10) Pub. No.: US 2017/0352189 A1
(43) Pub. Date: Dec. 7, 2017

(54) CONTENT DISPLAY METHOD USING MAGNET AND USER TERMINAL FOR PERFORMING SAME

(71) Applicant: WIDEVANTAGE INC., Seoul (KR)

(72) Inventor: Jae Yong GO, Seoul (KR)

(73) Assignee: WIDEVANTAGE INC., Seoul (KR)

(21) Appl. No.: 15/535,240

(22) PCT Filed: Dec. 18, 2015
(86) PCT No.: PCT/KR2015/013922

§ 371 Date: Jun. 12, 2017

(30) Foreign Application Priority Data
Dec. 19, 2014 (KR) 10-2014-0184611
Dec. 17, 2015 (KR) 10-2015-0181236

(51) Int. Cl. G06T 19/00; G06K 9/00; G01S 5/18; G06K 9/22; G01S 5/16

(52) U.S. Cl. CPC G06T 19/006; G06K 9/228; G01S 5/16; G01S 5/18; G06K 9/00671

(57) ABSTRACT

A contact display method and a user terminal for performing the same are disclosed. The disclosed content display method identifies content included in a surrounding area of a user terminal, determines a position of the user terminal relative to the content, and outputs a virtual object augmentatively to a blind image corresponding to a blind region covered by the user terminal, on the basis of the content and the position of the user terminal.

### TECHNICAL FIELD

Example embodiments relate to a contents display method and a user terminal performing the contents display method.

### BACKGROUND ART

An augmented reality refers to a mixture of a real image and a virtual image including a virtual object through an insertion of an image, for example, computer graphics, into a real environment. An augmented reality technology refers to technology that combines a real world and a virtual world, and thus enables a user to interact with a virtual object in real time.

An existing augmented reality technology may generate an augmented reality by capturing an image of a real object being separated far apart by a considerable distance and augmenting a virtual object into the captured image. Here, in a case of a large real object such as a table and a chair, in addition to a small real object such as a book, the large real object may need to be separated farther apart and a device displaying an augmented reality may need to be held continuously, and thus a user may experience inconvenience.

In related arts, Korean Patent Application No. 10-2010-0026720 entitled “Augmented reality system and method using light source recognition, and augmented reality processing apparatus for realizing the same” discloses an optical-based augmented reality.

### DISCLOSURE

### Technical Goals

An aspect provides a method and apparatus for minimizing heterogeneity between contents and a virtual object displayed on a user terminal by bring the contents into direct contact with a contents book including the contents or disposing the contents in close proximity to the contents book by the user terminal, and augmenting the virtual object and outputting the augmented virtual object.

### Technical Solutions

According to an aspect, there is provided a contents display method including identifying contents included in a surrounding region of a user terminal, determining a position of the user terminal relative to the contents, and augmenting a virtual object onto a blind image corresponding to a blind region covered by the user terminal and outputting the augmented virtual object, based on the contents and the position of the user terminal.

The user terminal may be disposed to be in contact with the surrounding region.

The contents display method may further include obtaining a surrounding image corresponding to the surrounding region of the user terminal. The determining of the position of the user terminal may include determining, from the surrounding image, the position of the user terminal relative to the contents.

The obtaining of the surrounding image may include obtaining the surrounding image using a front camera embedded in the user terminal and a mirror configured to reflect the surrounding image to the front camera.

The user terminal may be separated from the surrounding region by a preset distance through a support provided in the user terminal. The obtaining of the surrounding image may include obtaining the surrounding image using a rear camera embedded in the user terminal.

The obtaining of the surrounding image may include receiving the surrounding image including the surrounding region of the user terminal through a communicator embedded in the user terminal.

The determining of the position of the user terminal may include determining the position of the user terminal by identifying at least one of a contents pattern, a dot pattern, a visual marker, or a reference marker, which is included in the surrounding image.

The determining of the position of the user terminal may include identifying the contents included in the surrounding region by comparing, to information stored in a memory, at least one of the contents pattern, the dot pattern, the visual marker, or the reference object, which is included in the surrounding image.

The determining of the position of the user terminal may include determining further at least one of an arrangement angle or an arrangement direction of the user terminal relative to the contents. The augmenting of the virtual object onto the blind image and the outputting of the augmented virtual object may include augmenting the virtual object onto the blind image and outputting the augmented virtual object, based further on at least one of the arrangement angle or the arrangement direction of the user terminal.

The determining of the position of the user terminal may include determining the position of the user terminal using a magnetic field signal received from a magnetic field generator around the user terminal, or determining the position of the user terminal to using an audio signal received from an external speaker around the user terminal.

The determining of the position of the user terminal may include generating an audio signal to determine the position of the user terminal and transmitting the generated audio signal to an external device positioned around the user terminal, and determining the position of the user terminal using the audio signal received by the external device.

The augmenting of the virtual object onto the blind image and the outputting of the augmented virtual object may include determining the virtual object and a movement of the virtual object based on the contents and the position of the user terminal, and augmenting the virtual object onto the blind image and outputting the augmented virtual object based on the determined movement.

The augmenting of the virtual object onto the blind image and the outputting of the augmented virtual object may include augmenting the virtual object based on the contents onto the blind image and outputting the augmented virtual object, based on a change in the position of the user terminal.

The augmenting of the virtual object onto the blind image and the outputting of the augmented virtual object may include controlling at least one of a position, a shape, or a movement of the virtual object based on a user input signal that is input by a user, and augmenting the virtual object and outputting the augmented virtual object, based on the controlled one of the position, the shape, or the movement.

The identifying of the contents may include identifying the contents included in the surrounding region by identifying the contents pattern, the dot pattern, the visual marker, and the reference object included in the surrounding image of the user terminal.

The identifying of the contents may include identifying the contents included in the surrounding region by comparing, to the information stored in the memory, the contents pattern, the dot pattern, the visual marker, and the reference object included in the surrounding image of the user terminal.

The identifying of the contents may include identifying the contents included in the surrounding region by receiving identification information of the contents through the communicator.

The identifying of the contents may include identifying the contents through a signal input by a user, or identifying the contents based on the identification information of the contents received from a near-field communication (NFC) chip or a radio frequency (RF) chip around the user terminal.

According to another aspect, there is provided a user terminal including a processor configured to control augmentation of a virtual object, and a display configured to display an augmented virtual object. The processor may identify contents included in a surrounding region of the user terminal, determine a position of the user terminal relative to the contents, and augment the virtual object onto a blind image corresponding to a blind region covered by the user terminal and output the augmented virtual object, based on the contents and the position of the user terminal.

### Advantageous Effects

According to example embodiments described herein, heterogeneity between contents and a virtual object displayed on a user terminal may be minimized using the user terminal that brings the contents into direct contact with a contents book including the contents or disposes the contents in close proximity to the contents book, and augments the virtual object and outputs the augmented virtual object.

### BRIEF DESCRIPTION OF DRAWINGS

FIG. 1 is a diagram illustrating an operation of a user terminal according to an example embodiment.

FIG. 2 is a diagram illustrating a surrounding region and a blind region of a user terminal according to an example embodiment.

FIGS. 3 through 6 are diagrams illustrating examples of a method of obtaining a surrounding image corresponding to a surrounding region of a user terminal according to an example embodiment.

FIGS. 7 and 8 are diagrams illustrating examples of an operation of a user terminal using a reference object according to an example embodiment.

FIG. 9 is a diagram illustrating a method of determining a position of a user terminal using a magnetic field generator or an external speaker according to an example embodiment.

FIG. 10 is a diagram illustrating a user terminal according to an example embodiment.

FIG. 11 is a flowchart illustrating a contents display method according to an example embodiment.

### BEST MODE FOR CARRYING OUT THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. The features described herein may be embodied in different forms, and are not to be construed as being limited to the examples described herein.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Example embodiments to be described hereinafter may be applied to realize an augmented reality. The example embodiments may be embodied in various forms of products, for example, a smartphone, a smart pad, a wearable device, a tablet computer, a personal computer (PC), a laptop computer, and a smart home appliance. For example, the example embodiments may be applied to realize an augmented reality in, for example, a smartphone, a smart pad, and a wearable device. Hereinafter, the example embodiments will be described in detail by referring to the accompanying drawings, wherein like reference numerals refer to the like elements throughout.

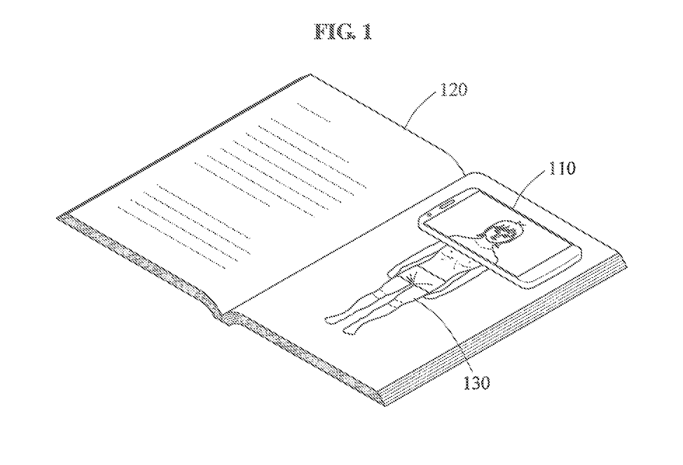

FIG. 1 is a diagram illustrating an operation of a user terminal according to an example embodiment.

Referring to FIG. 1, an augmented reality may be generated in a user terminal 110. The user terminal 110 is a device configured to generate an augmented reality, and provided in various computing devices and systems, such as, for example, a smartphone, a smart pad, a wearable device, a tablet computer, a PC, a laptop computer, and a smart home appliance.

The user terminal 110 is positioned on a contents book 120 including contents 130, and augments a virtual object into or onto an image of a portion of the contents 130 and outputs the augmented virtual object. By augmenting and outputting the virtual object while the user terminal 110 is being in direct contact with or in close proximity to the contents book 120, heterogeneity between the contents 130 and the virtual object displayed on the user terminal 110 may be minimized.

For example, in a case in which the contents 130 depicted as a human shape is printed on the contents book 120 as illustrated in FIG. 1, the user terminal 110 augments a virtual object onto an image of a portion of the contents 130 corresponding to a position of the user terminal 110 and outputs the augmented virtual object. Here, the user terminal 110 augments and outputs the virtual object based further on at least one of an arrangement angle or an arrangement direction of the user terminal 110 in addition to the position of the user terminal 110. The arrangement angle refers to an angular difference between the contents book 120 and the user terminal 110. For example, in a case in which the user terminal 110 is positioned on the contents book 120 as illustrated in FIG. 1, the arrangement angle of the user terminal 110 is 0°. The arrangement direction refers to a direction in which the user terminal 110 is positioned relative to the contents book 120.

The augmented virtual object may be controlled based on an input by a user. For example, additional information associated with a human head, for example, a head muscle and skull, may be augmented and displayed as a virtual object. Alternatively, in response to the input by the user, a virtual object representing a preset movement may he augmented and displayed.

In a case in which a size of the user terminal 110 is smaller than a size of the contents 130, the user terminal 110 may determine a partial image of an entire image of the contents 130 onto which the virtual object is to be augmented, by determining the position of the user terminal 130 relative to the contents 130. Alternatively, the user terminal 110 may determine the partial image onto which the virtual object is to be augmented based further on at least one of the arrangement angle or the arrangement direction of the user terminal 110 relative to the contents 130.

The contents 130 printed on the contents book 120 and the virtual object displayed on the user terminal 110, which are illustrated in FIG. 1, are provided for convenience of description, and thus a contents and a corresponding virtual object are not limited to the illustrated ones in FIG. 1 and various contents and virtual objects may be applied. Here, the contents book 120 refers to a medium including the contents 130, and various types of media including contents, for example, an augmented reality card, also referred to as an AR card, may be used as the contents book 120 and the description of the contents book 120 may thus be applied to such a media.

As a detailed operation of the user terminal 110, the user terminal 110 may identify the contents 130 included in a surrounding region of the user terminal 110, determine the position of the user terminal 130 relative to the contents 130, and output the virtual object to a display of the user terminal 110 based on the contents 130 and the position of the user terminal 110. Here, the virtual object may be augmented and output onto an image of the contents corresponding to a blind region covered by the user terminal 110. Hereinafter, the image of the contents corresponding to the blind region covered by the user terminal 110 will be referred to as a blind image for convenience of description.

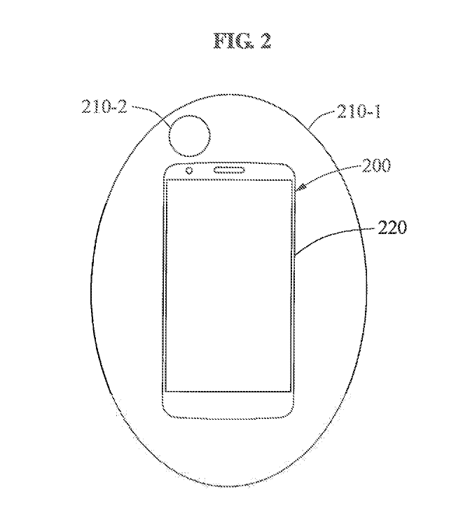

FIG. 2 is a diagram illustrating a surrounding region and a blind region of a user terminal according to an example embodiment.

Referring to FIG. 2, a surrounding region and a blind region 220 are determined based on a user terminal 200.

The surrounding region refers to a region from which at least one of a position, an arrangement angle, or an arrangement direction of the user terminal 200 is estimated. Any region from which at least one of the position, the arrangement angle, or the arrangement direction of the user terminal 200 is estimated may be used as the surrounding region. For example, as illustrated in FIG. 2, a relatively broad region 210-1 including the user terminal 200 is determined to be the surrounding region, or a relatively small region 210-2 being in close proximity to the user terminal 200 is determined to be the surrounding region. The user terminal 200 may determine the position of the user terminal 200 relative to contents based on a surrounding image corresponding to the surrounding region.

The blind region 220 refers to a region that is to be covered by the user terminal 200 in a region on which the contents is printed, and may be determined based on the position of the user terminal 200. Alternatively, the blind region 220 may be determined based further on at least one of the arrangement angle or the arrangement direction of the user terminal 200. The user terminal 200 may augment a virtual object into or onto a blind image corresponding to the blind region 220 and display the blind image corresponding to the blind region 220 and the augmented virtual object. Thus, the user terminal 200 may provide a user with the printed contents and the augmented virtual object without a region covered by the user terminal 200.

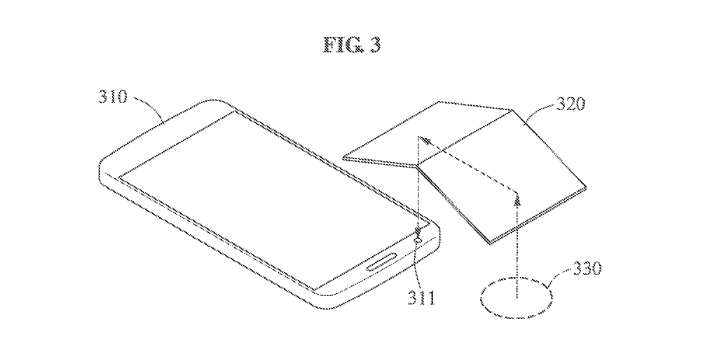

FIGS. 3 through 6 are diagrams illustrating examples of a method of obtaining a surrounding image corresponding to a surrounding region of a user terminal according to an example embodiment.

Referring to FIG. 3, a user terminal 310 obtains a surrounding image corresponding to a surrounding region 330 using a front camera 311 and a mirror 320.

The user terminal 310 includes the front camera 311 on a face on which a display is positioned. The front camera 311 captures the surrounding image corresponding to the surrounding region 330 using the mirror 320.

The mirror 320 is provided in the user terminal 310 and configured to reflect the surrounding image corresponding to the surrounding region 330 to the front camera 311, and includes a first sub mirror configured to reflect the surrounding image corresponding to the surrounding region 330 in a direction of the user terminal 310 and a second sub mirror configured to reflect, to the front camera 311, the surrounding image reflected by the first sub mirror.

In addition, a convex lens is additionally provided to concentrate, on the front camera 311, the surrounding image reflected by the second sub mirror.

Although a detailed structure in which the mirror 320 is provided in the user terminal 310 is not illustrated in FIG. 3, a detailed configuration or material of such a structure may be easily selected and determined by one of ordinary skill in the art to which the present disclosure pertains, and thus a more detailed description of the structure is omitted here for brevity.

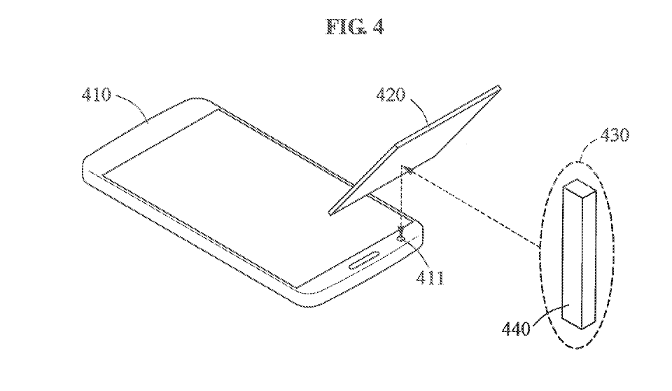

Referring to FIG. 4, a user terminal 410 obtains a surrounding image corresponding to a surrounding region 430 including a reference object 440, using a front camera 411 and a mirror 420.

The surrounding region 430 includes the reference object 440, which is a reference to be used to determine at least one of a position, an arrangement angle, or an arrangement direction of the user terminal 410. The user terminal 410 determines the position, the arrangement angle, and the arrangement direction of the user terminal 410 by analyzing the reference object 440 included in the surrounding image, using position information of the reference object 440 that is recognized in advance by the user terminal 410.

Here, the mirror 420 is provided in the user terminal 410 and configured to reflect the surrounding image corresponding to the surrounding region 430 to the front camera 411.

In addition, a convex lens is additionally provided to concentrate, on the front camera 411, the surrounding image reflected from the mirror 420.

Although a detailed structure in which the mirror 420 is provided in the user terminal 410 is not illustrated in FIG. 4, a detailed configuration or material of such a structure may be easily selected and determined by one of ordinary skill in the art to which the present disclosure pertains, and thus a more detailed description of the structure is omitted here for brevity.

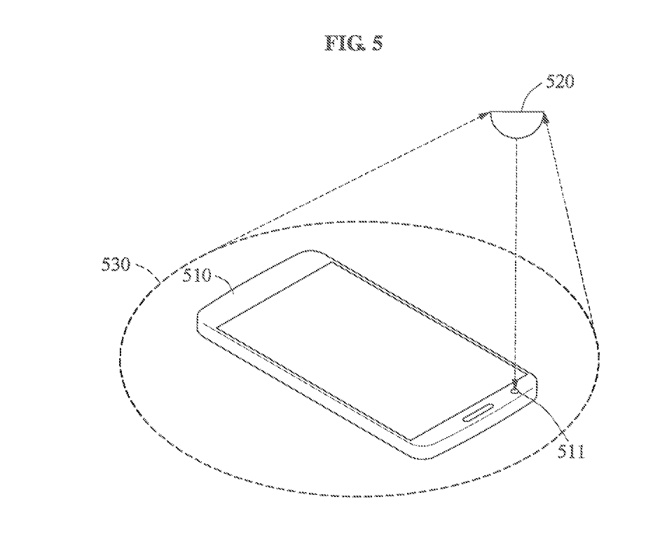

Referring to FIG. 5, a user terminal 510 obtains a surrounding image corresponding to a surrounding region 530 using a front camera 511 and a mirror 520.

The mirror 520 is provided in the user terminal 510 or positioned outside the user terminal 510, and configured to reflect the surrounding image corresponding to the surrounding region 530 to the front camera 511. For example, the mirror 520 may be a convex mirror configured to reflect the surrounding image corresponding to the surrounding region 530 including the user terminal 510.

In addition, a convex lens may be additionally provided to concentrate, on the front camera 511, the surrounding image reflected from the mirror 520.

Although a detailed structure in which the mirror 520 is provided in the user terminal 510 or the mirror 520 is positioned outside the user terminal 510 is not illustrated in FIG. 5, a detailed configuration or material of such a structure may be easily selected and determined by one of ordinary skill in the art to which the present disclosure pertains, and thus a more detailed description of the structure is omitted here for brevity.

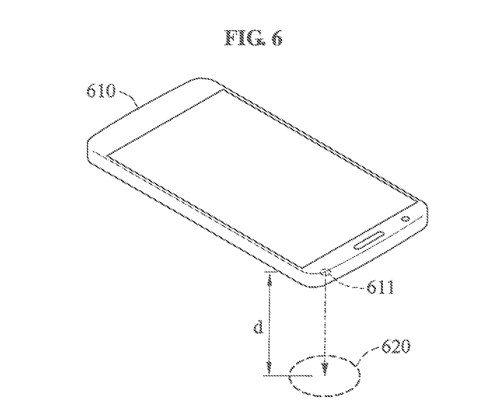

Referring to FIG. 6, a user terminal 610 obtains a surrounding image corresponding to a surrounding region 620 using a rear camera 611.

The user terminal 610 includes the rear camera 611 on a face on which a display is not positioned. The user terminal 610 obtains the surrounding image corresponding to the surrounding region 620 using the rear camera 611, while being separated from the surrounding region 620 by a preset distance d.

Here, the user terminal 610 may be separated from the surrounding region 620 by the distance d through a support provided in the user terminal 610. The support refers to a structure disposed on a face on which the surrounding region 620 is positioned and configured to support the user terminal 610, and may support the user terminal 610 to be separated from the surrounding region 620 by the distance d without a need for a user to hold the user terminal 610.

Although the support configured to separate the user terminal 610 from the surrounding region 620 by the distance d is not illustrated in detail in FIG. 6, a detailed configuration or material of such a support may be easily selected and determined by one of ordinary skill in the art to which the present disclosure pertains, and thus a more detailed description is omitted here for brevity.

Referring to FIGS. 3 through 6, a user terminal may identify, from an obtained surrounding image, contents included in a surrounding region. The user terminal may identify the contents included in the surrounding region by identifying at least one of a contents pattern, a dot pattern, a visual marker, or a reference object included in the surrounding image.

In detail, the user terminal may identify the contents included in the surrounding region by comparing at least one of the contents pattern, the dot pattern, the visual marker, or the reference object to information stored in a memory. In the memory, a reference image of at least one of the contents pattern, the dot pattern, the visual marker, or the reference object, and information associated with the reference image, for example, corresponding contents information, may be stored. The user terminal may identify the contents included in the surrounding region using the information stored in the memory.

The contents pattern refers to a pattern included in the contents, for example, a pattern forming a text, a sign, a figure, and a drawing.

The dot pattern refers to a pattern in which a plurality of dots is arranged by different distances at different intervals. The user terminal may identify the contents included in the surrounding region by identifying the dot pattern included in the surrounding image using stored information associated with the dot pattern.

In addition, the user terminal may determine, from the surrounding image, a position of the user terminal relative to the contents. The user terminal may identify the contents included in the surrounding region by comparing at least one of the contents pattern, the dot pattern, the visual marker, or the reference object included in the surrounding image to the information stored in the memory. In the memory, the reference image of at least one of the contents pattern, the dot pattern, the visual marker, or the reference object, and the information associated with the reference image, for example, corresponding position information, may be stored. The user terminal may determine the position of the user terminal from the surrounding image using the information stored in the memory. The user terminal may also determine, from the surrounding image, an arrangement angle and an arrangement direction of the user terminal, in addition to the position of the user terminal.

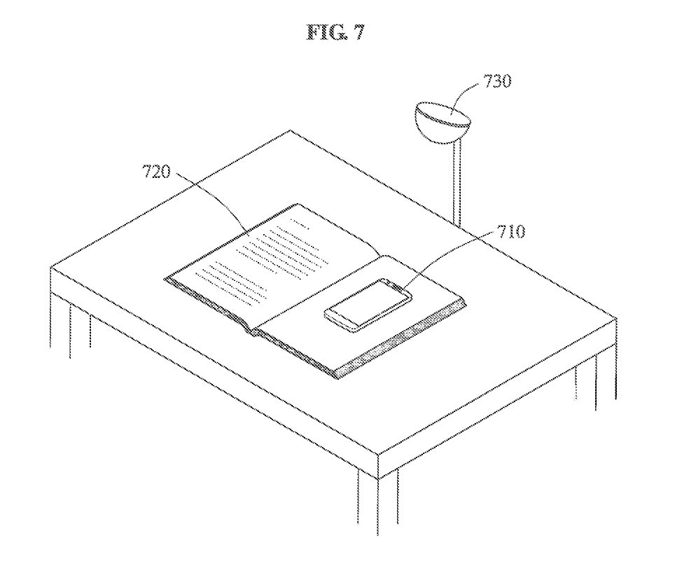

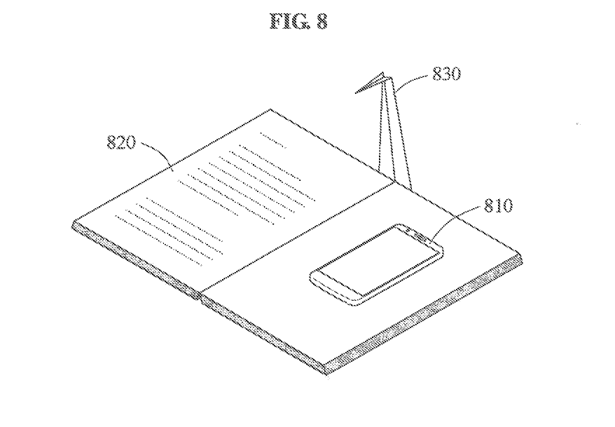

FIGS. 7 and 8 are diagrams illustrating examples of an operation of a user terminal using a reference object according to an example embodiment.

Referring to FIG. 7, using a reference object 730, a user terminal 710 obtains a surrounding image corresponding to a surrounding region of the user terminal 710 or determines a position of the user terminal 710. As described above, the user terminal 710 identifies contents included in the surrounding region using the obtained surrounding image, and determines the position of the user terminal 710. Alternatively, the user terminal 710 may further determine an arrangement angle and an arrangement direction of the user terminal 710 using the surrounding image.

The reference object 730 refers to a device that is used as a reference to identify contents included in a contents book 720 and determine at least one of the position, the arrangement angle, or the arrangement direction of the user terminal 710. As the reference object 730, various types of objects may be applied.

In one example, the reference object 730 reflects, to the user terminal 710, the surrounding image corresponding to the surrounding region. At a lower end of the reference object 730, a mirror is disposed to reflect the surrounding image corresponding to the surrounding region to the user terminal 710. The user terminal 710 obtains the surrounding image corresponding to the surrounding region using an embedded front camera and the mirror included in the reference object 730.

In another example, the reference object 730 captures the surrounding image corresponding to the surrounding region through an embedded camera, and provides the surrounding image to the user terminal 710. The reference object 730 may include the camera configured to capture the surrounding image corresponding to the surrounding region, a communicator configured to transmit the surrounding image to the user terminal 710, and a processor configured to control an operation of the reference object 730. The user terminal 710 receives the surrounding image corresponding to the surrounding region from the reference object 730 through the communicator.

In still another example, the reference object 730 provides a visual marker to the user terminal 710. The visual marker may be included in a hemispherical structure positioned at an upper end of the reference object 730. The visual marker is configured to allow different patterns to be shown based on an image capturing position.

The user terminal 710 captures the visual marker of the reference object using the embedded front camera. The user terminal 710 determines a current position of the user terminal 710 by comparing the captured visual marker of the reference object 730 to prestored visual marker information. Further, using the visual marker, the user terminal 710 determines the arrangement angle and the arrangement direction of the user terminal 710 in addition to the position of the user terminal 710.

Here, the user terminal 710 identifies the contents included in the contents book 720 through a signal input by a user, or identifies the contents included in the surrounding region by receiving identification information of the contents from, for example, an NFC chip and an RF chip of the contents book 720, through a communicator embedded in the user terminal 710.

Referring to FIG. 8, a user terminal 810 identifies contents included in a contents book 820, using a reference object 830 of the contents book 820 that is provided in a form of a pop-up book.

The contents book 820 is provided in such a form of the pop-up book that includes the reference object 830 unique to each page. The reference object 830 is included inside a page without being exposed outside the contents book 820 until the page including the reference object 830 is opened. When the page including the reference object 830 is opened, the reference object 830 may protrude from the page in three dimensions.

The user terminal 810 obtains a surrounding image corresponding to a surrounding region in which the reference object 830 is included, by capturing the reference object 830 using an embedded front camera.

The user terminal 810 identifies a currently open page among pages of the contents book 820 and determines contents included in the identified page, by identifying the reference object 830 included in the surrounding image.

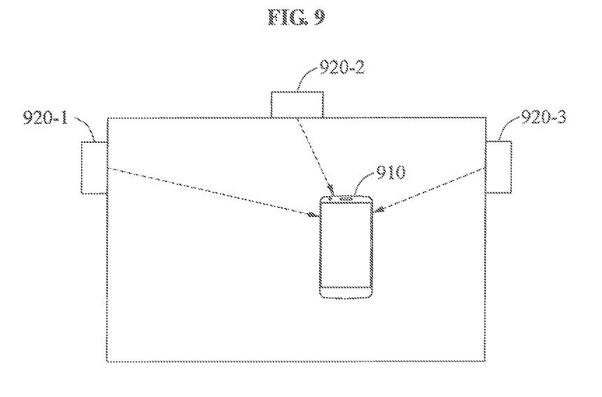

FIG. 9 is a diagram illustrating a method of determining a position of a user terminal using a magnetic field generator or an external speaker according to an example embodiment.

Referring to FIG. 9, a position of a user terminal 910 is determined based on information received from a plurality of external devices, for example, 920-1, 920-2, and 920-3.

The user terminal 910 is positioned on a face on which contents is illustrated, and the external devices 920-1, 920-2, and 920-3 are disposed around the user terminal 910.

In one example, the external devices 920-1, 920-2, and 920-3 include an external speaker configured to generate an audio signal. The audio signal transmitted from the external devices 920-1, 920-2, and 920-3 may be transmitted at a constant speed, and thus a transmission time of the audio signal may increase as a moving distance increases. Thus, the user terminal 910 determines the position of the user terminal 910 from positions of the external devices 920-1, 920-2, and 920-3 using times at which signals are received or an arrival time difference between the times. Further, in a case in which microphones are embedded in the user terminal 910, the user terminal 910 determines further at least one of an arrangement angle or an arrangement direction of the user terminal 910 by receiving an audio signal through the microphones.

In another example, the external devices 920-1, 920-2, and 920-3 include a magnetic field generator configured to generate a magnetic field signal. Here, at least one external device of the external devices 920-1, 920-2, and 920-3, generates a magnetic field signal. The magnetic field signal transmitted from the at least one of the external devices 920-1, 920-2, and 920-3 may have a magnitude or amplitude that is reduced based on a distance, and an incidence angle to be incident to the user terminal 910 may vary depending on the arrangement angle at which the user terminal 910 is arranged. Thus, the user terminal 910 determines the position, the arrangement angle, and the arrangement direction of the user terminal 910 based on a position of the at least one of the external devices 920-1, 920-2, and 920-3 by comparing magnitudes of received magnetic field signals. In a case in which a magnetic field signal is received from the at least one of the external devices 920-1, 920-2, and 920-3, the arrangement angle and the arrangement direction of the user terminal 910 may be determined in addition to the position of the user terminal 910.

The external devices 920-1, 920-2, and 920-3 may include the magnetic field generator such as a permanent magnet and an electromagnet, or the external speaker. That is, a signal transmitted from the external devices 920-1, 920-2, and 920-3 may be a magnetic field signal generated by the magnetic field generator or an audio signal generated by the external speaker. In response to the magnetic field signal being transmitted, the user terminal 910 receives the magnetic field signal through an embedded magnetic field sensor. In response to the audio signal being transmitted, the user terminal 910 receives the audio signal through an embedded microphone.

Here, the magnetic field signal generated by the magnetic field generator may be an alternating magnetic field signal having a magnetic field value or a frequency, which is incident with a magnitude and at an incidence angle in a triaxial magnetic field sensor of the user terminal 910. In a case in which a magnetic field signal having a magnitude and an incidence angle is used, the magnetic field generator may generate the magnetic field signal having a strength considerably greater than that of an environmental magnetic field such as an earth magnetic field so that the magnetic field sensor included in the user terminal 910 may measure the magnetic field signal without being affected by the environmental magnetic field.

Although not illustrated in FIG. 9, according to an another example embodiment, the user terminal 910 may generate an audio signal through an embedded speaker, and the generated audio signal may be transmitted to the external devices 920-1, 920-2, and 920-3. In such a case, the audio signal generated by the user terminal 910 is received through microphones embedded in the external devices 920-1, 920-2, and 920-3. The position, the arrangement angle, and the arrangement direction of the user terminal 910 may be determined based on reception times of audio signals received by the external devices 920-1, 920-2, and 920-3 or a time difference between the reception times. For example, the position, the arrangement angle, and the arrangement direction of the user terminal 910 may be determined in the external devices 920-1, 920-2, and 920-3, and determined resulting values may be transmitted from the external devices 920-1, 920-2, and 920-3 to the user terminal 910. Alternatively, information associated with the reception times or the time difference may be transmitted from the external devices 920-1, 920-2, and 920-3 to the user terminal 910, and the position, the arrangement angle, and the arrangement direction of the user terminal 910 may be determined in the user terminal 910 based on the information associated with the reception times or the time difference.

According to still another example embodiment, the user terminal 910 may generate a magnetic field signal through the embedded magnetic field generator, and the generated magnetic field signal may be transmitted to the external devices 920-1, 920-2, and 920-3. In such a case, the magnetic field signal generated by the user terminal 910 may be received through a magnetic field sensor embedded in the external devices 920-1, 920-2, and 920-3. The position, the arrangement angle, and the arrangement direction of the user terminal 910 may be determined through a comparison of magnitudes of magnetic field signals received by the external devices 920-1, 920-2, and 920-3. For example, the position, the arrangement angle, and the arrangement direction of the user terminal 910 may be determined in the external devices 920-1, 920-2, and 920-3 based on the magnitudes of the received magnetic field signals, and determined resulting values may be transmitted from the external devices 920-1, 920-2, and 920-3 to the user terminal 910. Alternatively, information associated with the magnitudes of the magnetic field signals received by the external devices 920-1, 920-2, and 920-3 may be transmitted to the user terminal 910, and the position, the arrangement angle, and the arrangement direction of the user terminal 910 may be determined in the user terminal 910 based on the information of the magnitudes of the magnetic field signals.

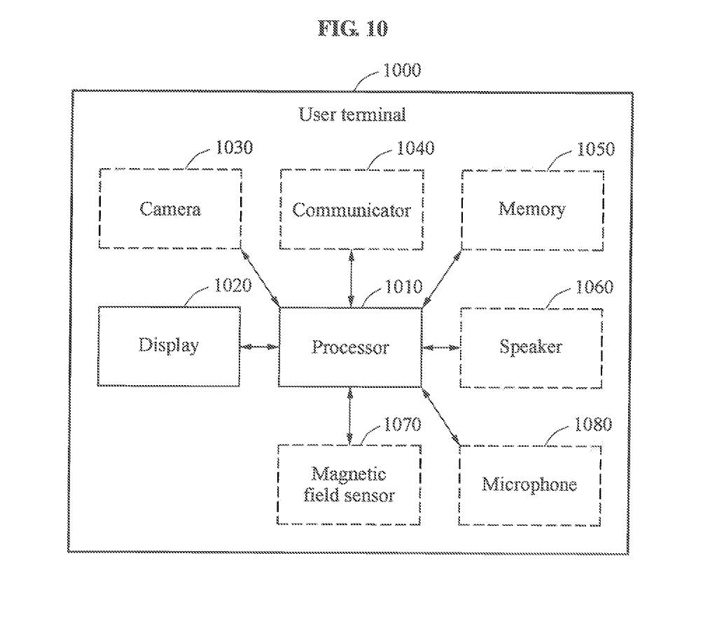

FIG. 10 is a diagram illustrating a user terminal according to an example embodiment.

Referring to FIG. 10, a user terminal 1000 includes a processor 1010 and a display 1020. In addition, the user terminal 1000 further includes a camera 1030, a communicator 1040, a memory 1050, a speaker 1060, a magnetic field sensor 1070, and a microphone 1080.

The processor 1010 may control augmentation of a virtual object. In addition, the processor 1010 may control operations of devices embedded in the user terminal 1000.

The processor 1010 may obtain a surrounding image corresponding to a surrounding region of the user terminal 1000. The processor 1010 may obtain the surrounding image using a front camera embedded in the user terminal 1000 and a mirror configured to reflect, to the front camera, the surrounding image corresponding to surrounding region. In addition, the processor 1010 may obtain the surrounding image using a rear camera embedded in the user terminal 1000. Further, the processor 1010 may receive the surrounding image including the user terminal 1000 and the surrounding region from a reference object through the communicator 1040.

The processor 1010 may identify contents included in the surrounding region of the user terminal 1000. In one example, the processor 1010 may identify the contents from the surrounding image corresponding to the surrounding region of the user terminal 1000. The processor 1010 may identify the contents by comparing at least one of a contents pattern, a dot pattern, a visual marker, or the reference object included in the surrounding image to information stored in the memory 1050. In another example, the processor 1010 may identify the contents included in the surrounding region by receiving identification information of the contents through the communicator 1040. Here, the identification information of the contents may be received from a contents book or from, for example, an NFC chip and an RF chip included in the reference object positioned around the user terminal 1000. For example, the contents book may include the NFC chip or the RF chip on each page that indicates a corresponding page, and the processor 1010 may receive the identification information of the contents from the NFC chip or the RF chip included in an unfolded page.

The processor 1010 may determine a position of the user terminal 1000 relative to the contents. In one example, the processor 1010 may determine the position of the user terminal 1000 relative to the contents using the surrounding image. The processor 1010 may determine the position of the user terminal 1000 by comparing at least one of the contents pattern, the dot pattern, the visual marker, or the reference object included in the surrounding image to the information stored hi the memory 1050. In another example, the processor 1010 may determine the position of the user terminal 1000 using a magnetic field signal received from a magnetic field generator around the user terminal 1000, or using an audio signal received from an external speaker around the user terminal 1000. Further, the processor 1010 may further determine, from the surrounding image, at least one of an arrangement angle or an arrangement direction of the user terminal 1000 in addition to the position of the user terminal 1000 relative to the contents.

The processor 1010 may augment a virtual object onto a blind image corresponding to a blind region covered by the user terminal 1000 based on the contents and the position of the user terminal 1000, and output the augmented virtual object. Here, a portion of the blind image that is output along with the virtual object may be covered by the virtual object, and thus not be output to the display 1020. In addition, the processor 1010 may change the blind image and output the changed blind image along with the virtual object. For example, the processor 1010 may change the blind image by changing a color of the blind image, twisting the blind image, or adding an animation to the blind image. As necessary, the processor 1010 may augment only the virtual object and output the augmented virtual object to the display 1020, excluding the blind image.

The processor 1010 may determine the virtual object and a movement of the virtual object based on the contents and the position of the user terminal 1000, and may augment and output the virtual object to the blind image based on the determined movement. In addition, the processor 1010 may augment and output the contents-based virtual object to the blind image based on a change in the position of the user terminal 1000.

The processor 1010 may control the virtual object based on a user input signal that is input by a user, for example, a touch signal, a drag signal, a button input signal, and a voice or speech signal, and output the controlled virtual object. Here, the user input signal may be received from the user through, for example, a touch sensor provided in the display 1020, and a button key and a microphone included in the user terminal 1000. The processor 1010 may control a position, a shape, and the movement of the virtual object based on the user input signal. In addition, the processor 1010 may change the blind image based on the user input signal, and output the changed blind image. For example, the processor 1010 may change the blind image and output the changed blind image by changing the color of the blind image, twisting the blind image, or adding an animation to the blind image, based on the user input signal.

The processor 1010 may augment the virtual object onto the blind image and output the augmented virtual object, based on the contents, and the position, the arrangement angle, and the arrangement direction of the user terminal 1000. An example of using the position of the user terminal 1000 is described for convenience of description. However, examples of the present disclosure are not limited to the example described in the foregoing, and the arrangement angle and the arrangement direction of the user terminal 1000 may be further considered.

For example, in a case in which the identified contents is a maze, the processor 1010 may augment, as a virtual object, a virtual character onto a blind image corresponding to a portion of the contents covered by the user terminal 1000, and output the augmented virtual character. In a case in which a user moves the user terminal 1000 along the maze, the processor 1010 may augment the virtual character moving in the maze and output the augmented virtual character. In a case in which the user incorrectly moves the user terminal 1000 out of the maze, the processor 1010 may output a message indicating that such a movement of the user terminal 1000 is incorrect using the augmented virtual character. In addition, in a case of a successful escape from the maze, the processor 1010 may output a message indicating the successful escape from the maze using the augmented virtual character.

For another example, in a case in which the identified contents is a certain item, the processor 1010 may augment a virtual object of the item corresponding to a position of the user terminal 1000, and output the augmented virtual object to the display 1020. For example, in a case in which the item is a mine, the processor 1010 may augment a virtual object in a situation in which the mine is exploded, and display the augmented virtual object. Also, in a case in which the item is an item that may be found by a virtual character, the processor 1010 may augment a virtual object in a situation in which the item is found by the virtual character, and display the augmented virtual object.

For still another example, in a case in which the identified contents is an enemy at a fighting game, the processor 1010 may identify the enemy corresponding to a position of the user terminal 1000, and augment a virtual object in a situation in which the identified enemy threatens a virtual character and output the augmented virtual object.

For yet another example, in a case in which the identified contents is a battlefield at a tank war game, the processor 1010 may augment, as a virtual object, a virtual tank corresponding to a position of the user terminal 1000. The augmented virtual tank may perform various operations, for example, firing a shell, based on a user input. Here, an additional terminal may be present in addition to the user terminal 1000, and a tank of an enemy may be augmented as a virtual object into the additional terminal and the augmented tank may be output to the additional terminal. In addition, a movement of the additional terminal may be automatically controlled based on an instruction of a computer, using an embedded wheel.

The display 1020 is a device disposed on a front face of the user terminal 1000, and may display the augmented virtual object along with the blind image. The display 1020 may include a touch sensor that may receive the user input signal, for example, a touch signal and a drag signal, from the user.

The camera 1030 is a device configured to capture an image and may include, for example, a first sub camera on a front face and a second sub camera on a rear face. The first sub camera may be disposed on a face on which the display 1020 is disposed, and the second sub camera may be disposed on a face on which the display 1020 is not disposed.

The communicator 1040 may perform communication with the reference object positioned around the user terminal 1000. The communicator 1040 may receive the surrounding image captured by the reference object.

The memory 1050 may record information as an electrical signal. For example, the memory 1050 may store the obtained surrounding image, or store a reference image of the contents pattern, the dot pattern, the visual marker, and the reference object and information associated with the reference image, for example, corresponding contents information and corresponding position information. In addition, information required for augmenting the virtual object may be already stored in the memory 1050.

The speaker 1060 is a device configured to reproduce an audio signal. For example, the speaker 1060 may reproduce an audio signal corresponding to the virtual object augmented by the processor 1010.

The magnetic field sensor 1070 is a device configured to detect a change in a magnetic field around the user terminal 1000, and may receive a magnetic field signal transmitted to the user terminal 1000. For example, the magnetic field sensor 1070 may receive a magnetic field signal transmitted from the magnetic field generator.

The microphone 1080 is a device configured to convert a sound generated around the user terminal 1000 to an electrical signal. For example, the microphone 1080 may receive an audio signal transmitted to the user terminal 1000. For example, the microphone 1080 may receive an audio signal transmitted from an external speaker.

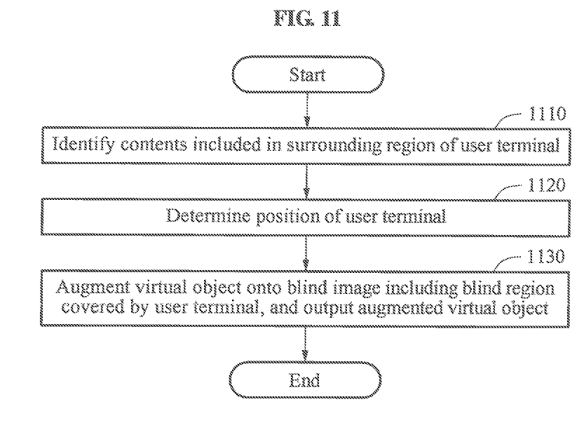

FIG. 11 is a flowchart illustrating a contents display method according to an example embodiment.

Referring to FIG. 11, a contents display method to be performed by a user terminal includes operation 1110 of identifying contents included in a surrounding region of the user terminal, operation 1120 of determining a position of the user terminal relative to the contents, and operation 1130 of augmenting a virtual object onto a blind image corresponding to a blind region covered by the user terminal based on the contents and the position of the user terminal and outputting the augmented virtual object.

The descriptions provided with reference to FIGS. 1 through 10 may be applied to the operations described with reference to FIG. 11, and thus a repeated and more detailed description will be omitted here for brevity.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

Example embodiments include non-transitory computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts. Examples of non-transitory computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A contents display method comprising:
identifying contents included in a surrounding region of a user terminal;
determining a position of the user terminal relative to the contents; and
augmenting a virtual object onto a blind image corresponding to a blind region covered by the user terminal based on the contents and the position of the user terminal, and outputting the augmented virtual object.

2. The contents display method of claim 1, wherein the user terminal is disposed in contact with the surrounding region.

3. The contents display method of claim 1, further comprising:
obtaining a surrounding image corresponding to the surrounding region of the user terminal,
wherein the determining of the position of the user terminal comprises:
determining, from the surrounding image, the position of the user terminal relative to the contents.

4. The contents display method of claim 3, wherein the obtaining of the surrounding image comprises:
obtaining the surrounding image using a front camera embedded in the user terminal and a mirror configured to reflect the surrounding image to the front camera.

5. The contents display method of claim 3, wherein the user terminal is separated from the surrounding region by a preset distance through a support provided in the user terminal, and
the obtaining of the surrounding image comprises:
obtaining the surrounding image using a rear camera embedded in the user terminal.

6. The contents display method of claim 3, wherein the obtaining of the surrounding image comprises:
receiving the surrounding image including the surrounding region of the user terminal through a communicator embedded in the user terminal.

7. The contents display method of claim 3, wherein the determining of the position of the user terminal comprises:
determining the position of the user terminal by identifying at least one of a contents pattern, a dot pattern, a visual marker, or a reference marker, which is included in the surrounding image.

8. The contents display method of claim 7, wherein the determining of the position of the user terminal comprises:
identifying the contents included in the surrounding region by comparing, to information stored in a memory, at least one of the contents pattern, the dot pattern, the visual marker, or the reference object, which is included in the surrounding image.

9. The contents display method of claim 1, wherein the determining of the position of the user terminal comprises:
determining further at least one of an arrangement angle or an arrangement direction of the user terminal relative to the contents, and
the augmenting of the virtual object onto the blind image and the outputting of the augmented virtual object comprises:
augmenting the virtual object onto the blind image and outputting the augmented virtual object, further based on at least one of the arrangement angle or the arrangement direction of the user terminal.

10. The contents display method of claim 1, wherein the determining of the position of the user terminal comprises:
determining the position of the user terminal using a magnetic field signal received from a magnetic field generator around the user terminal; or
determining the position of the user terminal using an audio signal received from an external speaker around the user terminal.

11. The contents display method of claim 1, wherein the determining of the position of the user terminal comprises:
generating an audio signal to determine the position of the user terminal and transmitting the generated audio signal to an external device positioned around the user terminal, and determining the position of the user terminal using the audio signal received by the external device.

12. The contents display method of claim 1, wherein the augmenting of the virtual object onto the blind image and the outputting of the augmented virtual object comprises:
determining the virtual object and a movement of the virtual object based on the contents and the position of the user terminal, and augmenting the virtual object onto the blind image and outputting the augmented virtual object, based on the determined movement.

13. The contents display method of claim 1, wherein the augmenting of the virtual object onto the blind image and the outputting of the augmented virtual object comprises:
augmenting the virtual object based on the contents onto the blind image and outputting the augmented virtual object, based on a change in the position of the user terminal.

14. The contents display method of claim 1, wherein the augmenting of the virtual object onto the blind image and the outputting of the augmented virtual object comprises:
controlling at least one of a position, a shape, or a movement of the virtual object based on a user input signal that is input by a user, and augmenting the virtual object and outputting the augmented virtual object based on the controlled one of the position, the shape, or the movement.

15. The contents display method of claim 1, wherein the identifying of the contents comprises:
identifying the contents included in the surrounding region by identifying a contents pattern, a dot pattern, a visual marker, and a reference object included in the surrounding image of the user terminal.

16. The contents display method of claim 15, wherein the identifying of the contents comprises:
identifying the contents included in the surrounding region by comparing, to information stored in a memory, the contents pattern, the dot pattern, the visual marker, and the reference object included in the surrounding image of the user terminal.

17. The contents display method of claim 1, wherein the identifying of the contents comprises:
identifying the contents included in the surrounding region by receiving identification information of the contents through a communicator.

18. The contents display method of claim 1, wherein the identifying of the contents comprises:
identifying the contents through a signal input by a user, or identifying the contents based on identification information of the contents received from a near-field communication (NFC) chip or a radio frequency (RF) chip around the user terminal.

19. A non-transitory computer-readable medium comprising a program for instructing a computer to perform the method of claim 1.

20. A user terminal comprising:
a processor configured to control augmentation of a virtual object; and
a display configured to display an augmented virtual object,
wherein the processor is configured to identify contents included in a surrounding region of the user terminal,
determine a position of the user terminal relative to the contents, and
augment the virtual object onto a blind image corresponding to a blind region covered by the user terminal based on the contents and the position of the user terminal, and output the augmented virtual object.

21. The user terminal of claim 20, being in contact with the surrounding region.

22. The user terminal of claim 20, further comprising:
a camera configured to capture a surrounding image corresponding to the surrounding region of the user terminal,
wherein the processor is configured to determine, from the surrounding image, the position of the user terminal relative to the contents.

23. The user terminal of claim 22, wherein the camera includes a front camera configured to capture the surrounding image using a mirror configured to reflect the surrounding image to the camera embedded in the user terminal.

24. The user terminal of claim 22, wherein the camera includes a rear camera embedded in the user terminal being separated from the surrounding region by a preset distance and configured to capture the surrounding image, and
the user terminal being separated from the surrounding region by the preset distance through a support provided in the user terminal.

25. The user terminal of claim 22, wherein the processor is configured to determine the position of the user terminal by identifying at least one of a contents pattern, a dot pattern, a visual marker, or a reference object, which is included in the surrounding image.

26. The user terminal of claim 20, wherein the processor is configured to further determine at least one of an arrangement angle or an arrangement direction of the user terminal relative to the contents, and
augment the virtual object onto the blind image and output the augmented virtual object, based on the at least one of the arrangement angle or the arrangement direction of the user terminal.

27. The user terminal of claim 20, wherein the processor is configured to determine the virtual object and a movement of the virtual object based on the contents and the position of the user terminal, and augment the virtual object onto the blind image and output the augmented virtual object based on the determined movement.
